(19) United States
(12) Patent Application Publication
(10) Pub. No.: US 2017/0171378 A1
(43) Pub. Date: Jun. 15, 2017

(54) METHOD AND ELECTRONIC DEVICE FOR ANSWERING MOBILE PHONE CALL

(71) Applicants: Le Holdings (Beijing) Co., Ltd., Beijing (CN); Lemobile Information Technology (Beijing) Co., Ltd., Beijing (CN)

(72) Inventor: Junhui CHU, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/247,767

(22) Filed: Aug. 25, 2016

Related U.S. Application Data
(63) Continuation of application No. PCT/CN2016/088529, filed on Jul. 5, 2016.

(30) Foreign Application Priority Data
Dec. 15, 2015 (CN) 201510933141.3

(51) Int. Cl. H04M 1/725; H04M 1/02; H04W 4/02

(52) U.S. Cl. CPC H04M 1/72569; H04W 4/027; H04M 1/72577; H04M 1/0281

(57) ABSTRACT

This disclosure provides a method and electronic device for operating a mobile phone, including: acquiring a first kinematic acceleration of a mobile phone when the mobile phone has an incoming call; judging whether the first kinematic acceleration is greater than a first threshold or not, and answering the incoming call if the first kinematic acceleration is greater than the first threshold. As the acquisition of the first kinematic acceleration of the mobile phone is started only when the mobile phone has an incoming call, the energy consumption is saved; and meanwhile, as the first kinematic acceleration will be greater than the first threshold when a user does an action of shaking or the like, the user can answer a call through a shaking action, which is convenient for operation, achieves answering an incoming call with one hand, and is suitable for large-screen smart phones.

### CROSS REFERENCE TO RELATED APPLICATIONS

This disclosure is a continuation of International Application No. PCT/CN2016/088529, filed on Jul. 5, 2016, which is based upon and claims priority to Chinese Patent Application No. 201510933141.3, filed on Dec. 15, 2015, titled “METHOD AND SYSTEM FOR ANSWERING AND HANGING UP INCOMING CALL OF MOBILE PHONE”, and the entire contents of which are incorporated herein by reference.

### TECHNICAL FIELD

This disclosure relates to the field of mobile communication equipment, and specifically relates to a method and electronic device for operating a mobile phone.

### BACKGROUND

With the development of mobile communication technology and the continuous improvement of people's living standard, all kinds of mobile communication devices have become indispensable communication tools in people's life. A smart phone, as an important mobile communication device in people's daily life, has a huge user group.

At present, most of smart phones dominating the mainstream consumer market are equipped with touch screens, and when a mobile phone has an incoming call, a user can control answering or hanging up the incoming call by sliding or touching the touch screen. In the times of small mobile phone screens, it is easy to operate mobile phones with one hand. In recent years, as users have increasingly higher visual requirements, screens of the smart phones are getting bigger and bigger, so that it is more difficult for a user to operate a touch screen with one hand. For example, an incoming call is likely to be answered by sliding or touching a touch screen with both hands, which is inconvenient for users.

### SUMMARY

This disclosure provides a method and electronic device for operating a mobile phone, which is convenient for operation, realizes answering or hanging up an incoming call with one hand, and is suitable for large-screen smart phones.

One objective of the embodiments of this disclosure is to provide a method for operating a mobile phone, including the following steps:

judging whether a mobile phone has an incoming call or not; acquiring a first kinematic acceleration of the mobile phone if the mobile phone has an incoming call;

judging whether the first kinematic acceleration is greater than a first threshold or not; and answering the incoming call if the first kinematic acceleration is greater than the first threshold.

Preferably, the step of acquiring the first kinematic acceleration of the mobile phone includes:

acquiring a first acceleration of an X axis of the mobile phone in a horizontal moving direction; acquiring a second acceleration of a Y axis of the mobile phone in a vertical moving direction; acquiring a third acceleration of a Z axis in an earth gravity field direction; and

obtaining the first kinematic acceleration according to the first acceleration, the second acceleration and the third acceleration.

Preferably, the step of obtaining the first kinematic acceleration according to the first acceleration, the second acceleration and the third acceleration is:

N=\sqrt{X²+Y²+Z²}, where

N is the first kinematic acceleration;
X is the first acceleration;
Y is the second acceleration; and
Z is the third acceleration.

Preferably, the method also includes the following steps:

further judging whether the first kinematic acceleration is greater than a second threshold or not when the first kinematic acceleration is not greater than the first threshold, where the second threshold is smaller than the first threshold; and

further acquiring a second kinematic acceleration of the mobile phone if the first kinematic acceleration is greater than the second threshold, judging whether the second kinematic acceleration is greater than the second threshold or not, and hanging up the incoming call if the second kinematic acceleration is greater than the second threshold.

Preferably, the method also includes:

judging whether the mobile phone is busy, and acquiring a third kinematic acceleration of the mobile phone if the mobile phone is busy; and

judging whether the third kinematic acceleration is greater than the first threshold or not, and hanging up the incoming call if the third kinematic acceleration is greater than the first threshold.

Preferably, the method also includes:

judging whether the mobile phone is busy or not, and acquiring a third kinematic acceleration of the mobile phone if the mobile phone is busy; and

judging whether the third kinematic acceleration is greater than the first threshold or not, and hanging up the call if the third kinematic acceleration is greater than the first threshold.

Another objective of the embodiments of this disclosure is to provide an electronic device, including: at least one processor, and a memory in communication connection with the at least one processor, where the memory stores instructions that can be executed by the at least one processor, and the instructions are executed by the at least one processor to enable the at least one processor to: judge whether a mobile phone has an incoming call or not, and acquire a first kinematic acceleration of the mobile phone if the mobile phone has an incoming call; and judge whether the first kinematic acceleration is greater than a first threshold or not, and answer the incoming call if the first kinematic acceleration is greater than the first threshold.

For the electronic device, where, the step of acquiring the first kinematic acceleration of the mobile phone includes: acquiring a first acceleration of an X axis of the mobile phone in a horizontal moving direction, acquiring a second acceleration of a Y axis of the mobile phone in a vertical moving direction, and acquiring a third acceleration of a Z axis in an earth gravity field direction; and obtaining the first kinematic acceleration according to the first acceleration, the second acceleration and the third acceleration.

For the electronic device, where, the mode of obtaining the first kinematic acceleration according to the first acceleration, the second acceleration and the third acceleration is:

N=\sqrt{X²+Y²+Z²}, where

N is the first kinematic acceleration;
X is the first acceleration;
Y is the second acceleration; and
Z is the third acceleration.

The electronic device further judges whether the first kinematic acceleration is greater than a second threshold or not when the first kinematic acceleration is not greater than the first threshold, where the second threshold is smaller than the first threshold; and if the first kinematic acceleration is greater than the second threshold, then further acquires a second kinematic acceleration of the mobile phone, and judges whether the second kinematic acceleration is greater than the second threshold or not, and hangs up the incoming call if the second kinematic acceleration is greater than the second threshold.

For the electronic device, where, the memory stores instructions that can be executed by the at least one processor, and the instructions are executed by the at least one processor to enable the at least one processor to: judge whether a mobile phone is busy, acquire a third kinematic acceleration of the mobile phone if the mobile phone is busy; judge whether the third kinematic acceleration is greater than the first threshold or not, and hang up the call if the third kinematic acceleration is greater than the first threshold.

Another objective of the embodiments of this disclosure is to provide a non-volatile computer storage medium storing computer executable instructions that, when executed by the electronic device, enable the electronic device to: judge whether a mobile phone has an incoming call or not, and acquire a first kinematic acceleration of the mobile phone if the mobile phone has an incoming call; judge whether the first kinematic acceleration is greater than a first threshold or not, and answer the incoming call if the first kinematic acceleration is greater than the first threshold.

For the volatile computer storage medium, where the step of acquiring the first kinematic acceleration of the mobile phone includes: acquiring a first acceleration of an X axis of the mobile phone in a horizontal moving direction, acquiring a second acceleration of a Y axis of the mobile phone in a vertical moving direction, acquiring a third acceleration of a Z axis in an earth gravity field direction; and obtaining the first kinematic acceleration according to the first acceleration, the second acceleration and the third acceleration.

For the non-volatile computer storage medium, where, the mode of obtaining the first kinematic acceleration according to the first acceleration, the second acceleration and the third acceleration is:

N=\sqrt{X²+Y²+Z²}, where

N is the first kinematic acceleration;
X is the first acceleration;
Y is the second acceleration; and
Z is the third acceleration.

The non-volatile computer storage medium further judges whether the first kinematic acceleration is greater than a second threshold or not when the first kinematic acceleration is not greater than the first threshold, where the second threshold is smaller than the first threshold; and further acquires a second kinematic acceleration of the mobile phone if the first kinematic acceleration is greater than the second threshold, judges whether the second kinematic acceleration is greater than the second threshold or not, and hangs up the incoming call if the second kinematic acceleration is greater than the second threshold.

The non-volatile computer storage medium judges whether the mobile phone is busy, acquires the third kinematic acceleration of the mobile phone if the mobile phone is busy; judges whether the third kinematic acceleration is greater than the first threshold or not, and hangs up the call if the third kinematic acceleration is greater than the first threshold.

The method and electronic device for operating a mobile phone provided by the embodiments of this disclosure acquire a first kinematic acceleration of the mobile phone when the mobile phone has an incoming call, judge whether the first kinematic acceleration is greater than a first threshold or not, and answer the incoming call if the first kinematic acceleration is greater than a first threshold. As the acquisition of the first kinematic acceleration of the mobile phone is started only when the mobile phone has an incoming call, the energy consumption is saved; and meanwhile, as the first kinematic acceleration will be greater than the first threshold when a user does an action of shaking or the like, the user can answer a call through a shaking action, which is clear and reliable, is convenient for operation, achieves the effect of answering an incoming call with one hand, and is suitable for large-screen smart phones.

The method and electronic device for operating a mobile phone provided by the embodiments of this disclosure acquire a first acceleration of an X axis of the mobile phone in a horizontal moving direction, acquire a second acceleration of a Y axis of the mobile phone in a vertical moving direction, acquire a third acceleration of a Z axis in an earth gravity field direction, and then obtain the first kinematic acceleration according to the first acceleration, the second acceleration and the third acceleration. This technical method is simple and reliable, and can be implemented by an acceleration transducer at relatively low cost.

The method and electronic device for operating a mobile phone provided by the embodiments of this disclosure further judge whether the first kinematic acceleration is greater than a second threshold or not when the first kinematic acceleration is not greater than the first threshold, where the second threshold is smaller than the first threshold; further acquire a second kinematic acceleration of the mobile phone if the first kinematic acceleration is greater than the second threshold, judge whether the second kinematic acceleration is greater than the second threshold or not, and hang up the incoming call if the second kinematic acceleration is greater than the second threshold. With such setting, an incoming call will be hung up when a user shakes the mobile phone twice with a relatively small force, and as the incoming call will be hung up only after two times of judgment, thereby avoiding hang-up by mistake and achieving good reliability.

The method and electronic device for operating a mobile phone provided by the embodiments of this disclosure acquire a third kinematic acceleration of the mobile phone when the mobile phone is busy, judge whether the third kinematic acceleration is greater than the first threshold or not, and hang up the call if the third kinematic acceleration is greater than the first threshold. A user can hang up a call through a shaking action, which is convenient for operation, achieves the effect of hanging up a call with one hand, and is suitable for large-screen smart phones.

### BRIEF DESCRIPTION OF THE DRAWINGS

One or more embodiments are illustrated by way of example, and not by limitation, in the figures of the accompanying drawings, where elements having the same reference numeral designations represent like elements throughout. The drawings are not to scale, unless otherwise disclosed.

FIG. 1 is a flow diagram of a specific example of a method for operating a mobile phone in accordance with embodiment 1 of this disclosure;

FIG. 2 is a structural block diagram of a specific example of a mobile phone operating system in accordance with embodiment 2 of this disclosure;

FIG. 3 is a structural block diagram of another specific example of a mobile phone operating system in accordance with embodiment 2 of this disclosure;

FIG. 4 is a schematic diagram of a hardware structure of an electronic device for executing a method for answering an incoming call of a mobile phone in accordance with embodiment 4 of this disclosure; and

FIG. 5 is a schematic diagram of a hardware structure of an electronic device for executing a method for hanging up a call of a mobile phone in accordance with embodiment 4 of this disclosure.

The reference numerals in the drawings are as follows: 1—first kinematic acceleration acquisition module, 2—monitoring module, 10—third kinematic acceleration acquisition module, 11—monitoring module, 3 and 5—memories, and 4 and 6—processors.

### DETAILED DESCRIPTION

To make the objectives, the technical solution and the advantages of the embodiments of this disclosure clearer, the technical solution of this disclosure will be clearly and completely described hereinafter through implementation with reference to the accompanying drawings in the embodiments of this disclosure. Apparently, the embodiments described below are part, instead of all, of the embodiments of this disclosure.

### Embodiment 1

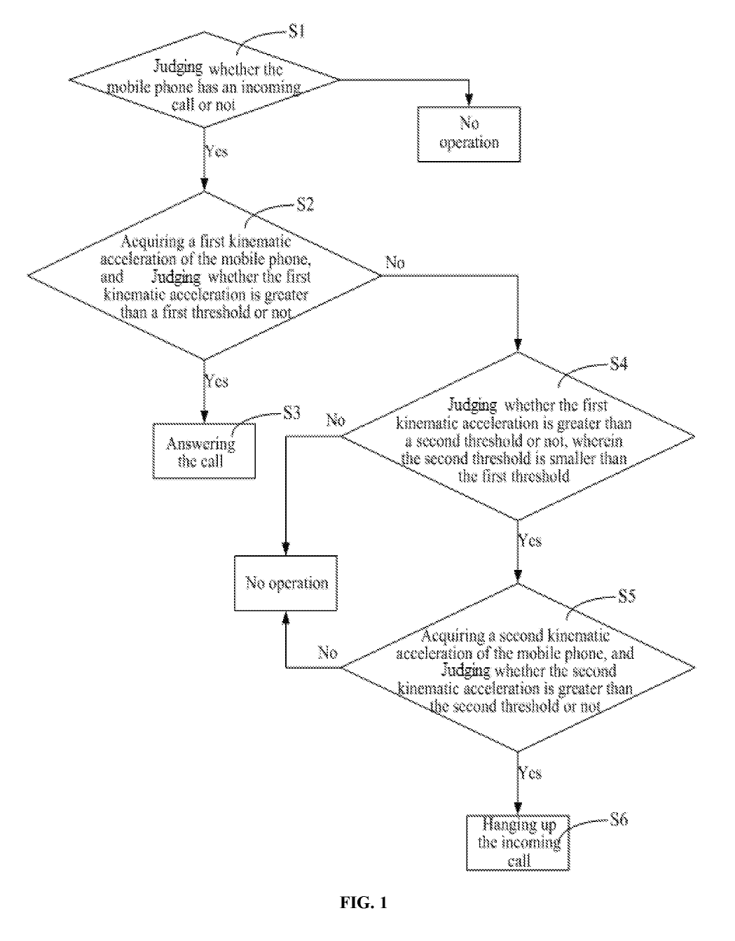

As shown in FIG. 1, a method for operating a mobile phone provided by the present embodiment includes the following steps:

S1: judging whether a mobile phone has an incoming call or not, and turning to step S2 if the mobile phone has an incoming call;

S2: acquiring a first kinematic acceleration of the mobile phone, judging whether the first kinematic acceleration is greater than a first threshold or not, and turning to step S3 if the first kinematic acceleration is greater than the first threshold, or otherwise, turning to step S4;

S3: answering the incoming call;

S4: judging whether the first kinematic acceleration is greater than a second threshold or not; where the second threshold is smaller than the first threshold; and turning to step S5 if the first kinematic acceleration is greater than the second threshold, or otherwise, performing no operation;

S5: acquiring a second kinematic acceleration of the mobile phone, judging whether the second kinematic acceleration is greater than the second threshold or not, and turning to step S6 if the second kinematic acceleration is greater than the second threshold, or otherwise, performing no operation; and

S6: hanging up the incoming call.

Through the steps S1-S3, the acquisition of the first kinematic acceleration of the mobile phone is started only when the mobile phone has an incoming call, and thus the energy consumption is saved; and meanwhile, as the first kinematic acceleration will be greater than the first threshold when a user does an action of shaking or the like, the user can answer a call through a shaking action, which is convenient for operation, achieves the effect of answering a call with one hand, and is suitable for large-screen smart phones.

Through the steps S4-S6, an incoming call will be hung up when a user shakes the mobile phone twice with a relatively small force, and as the incoming call will be hung up only after two times of judgment, thereby avoiding hang-up by mistake and achieving good reliability.

Based on the abovementioned solution, the step of acquiring the first kinematic acceleration of the mobile phone in the step S2 includes:

firstly, acquiring a first acceleration of an X axis of the mobile phone in a horizontal moving direction, acquiring a second acceleration of a Y axis of the mobile phone in a vertical moving direction, and acquiring a third acceleration of a Z axis in an earth gravity field direction; and

secondly, obtaining the first kinematic acceleration according to the first acceleration, the second acceleration and the third acceleration. As a specific embodiment, N=\sqrt{X²+Y²+Z²}, where N is the first kinematic acceleration, X is the first acceleration, Y is the second acceleration, and Z is the third acceleration.

The method for acquiring the first kinematic acceleration in this way is simple and reliable, and can be implemented by an acceleration transducer at low cost. It will be appreciated by those skilled in the art that a second kinematic acceleration and a third kinematic acceleration can be obtained in the same way.

The present embodiment also provides a method for hanging up a call of a mobile p hone, including the following steps: firstly, judging whether the mobile phone is busy, and acquiring a third kinematic acceleration of the mobile phone if the mobile phone is busy; and secondly, judging whether the third kinematic acceleration is greater than the first threshold or not, and hanging up the call if the third kinematic acceleration is greater than the first threshold. A user can hang up a call through a shaking action, which is convenient for operation, achieves the effect of hanging up a call with one hand, and is suitable for large-screen smart phones.

### Embodiment 2

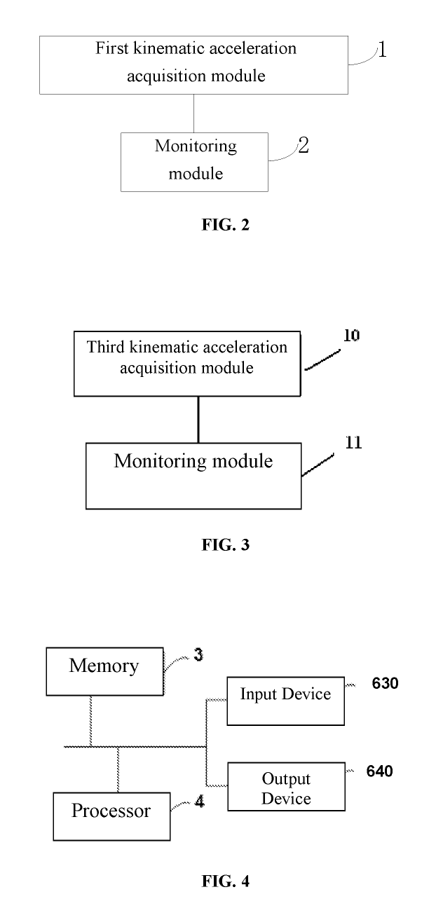

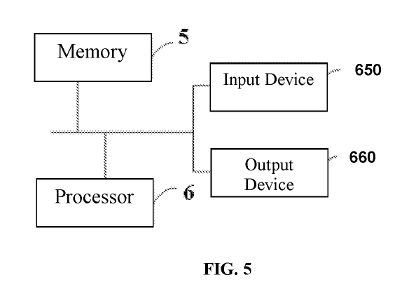

As shown in FIG. 2, the present embodiment provides a mobile phone operating system, including the following modules:

a first kinematic acceleration acquisition module 1, for, when the mobile phone has an incoming call, acquiring a first kinematic acceleration of the mobile phone and sending the first kinematic acceleration to a monitoring module 2; and

the monitoring module 2, for judging whether the first kinematic acceleration is greater than a first threshold or not, and answering the incoming call if the first kinematic acceleration is greater than the first threshold.

According to the mobile phone operating system provided by the present embodiment, the acquisition of the first kinematic acceleration of the mobile phone is started only when the mobile phone has an incoming call, and thus the energy consumption is saved; and meanwhile, as the first kinematic acceleration will be greater than the first threshold when a user does an action of shaking or the like, the user can answer a call only by a shaking action, which is convenient for operation, achieves the effect of answering an incoming call with one hand, and is suitable for large-screen smart phones.

Based on the abovementioned solution, the first kinematic acceleration acquisition module 1 may further include the following sub-modules:

a tri-axial acceleration acquisition sub-module, for acquiring a first acceleration of an X axis of the mobile phone in a horizontal moving direction, acquiring a second acceleration of a Y axis of the mobile phone in a vertical moving direction, and acquiring a third acceleration of a Z axis in an earth gravity field direction; and

a resulting sub-module, for acquiring the first kinematic acceleration according to the first acceleration, the second acceleration and the third acceleration. As a specific embodiment, N=\sqrt{X²+Y²+Z²}, where N is the first kinematic acceleration, X is the first acceleration, Y is the second acceleration, and Z is the third acceleration.

The method for acquiring the first kinematic acceleration in this way is simple and reliable, and can be implemented by an acceleration transducer at low cost. It will be appreciated by those skilled in the art that a second kinematic acceleration and a third kinematic acceleration can be obtained in the same way.

Based on the abovementioned solution, the mobile phone operating system provided by the present embodiment may also include: a monitoring module, which is also used for, when the first kinematic acceleration is not greater than the a threshold, further judging whether the first kinematic acceleration is greater than a second threshold or not; sending an instruction for acquiring a second kinematic acceleration to a second kinematic acceleration acquisition module if the first kinematic acceleration is greater than a second threshold, where the second threshold is smaller than the first threshold; the second kinematic acceleration acquisition module, which is used for, when the instruction for acquiring the second kinematic acceleration is received, acquiring the second kinematic acceleration of the mobile phone and sending the second kinematic acceleration to the monitoring module; and the monitoring module, which is also used for judging whether the second kinematic acceleration is greater than the second threshold or not, and hanging up the incoming call if the second kinematic acceleration is greater than the second threshold. According to this embodiment, an incoming call will be hung up when a user shakes the mobile phone twice with a relatively small force, and as the incoming call will be hung up only after two times of judgment, thereby avoiding hang-up by mistake and achieving good reliability.

Preferably, the system also includes: a third kinematic acceleration acquisition module 10 for, when the mobile phone is busy, acquiring a third kinematic acceleration of the mobile phone and sending the third kinematic acceleration to a monitoring module; and a monitoring module 11 for judging whether the third kinematic acceleration is greater than the first threshold or not, and hanging up the call if the third kinematic acceleration is greater than the first threshold. A user can hang up a call by a shaking action, which is convenient for operation, achieves the effect of hanging up a call with one hand, and is suitable for large-screen smart phones.

### Embodiment 3

The present embodiment provides a non-volatile computer storage medium, storing computer executable instructions that can be used for executing the method for operating a mobile phone in any one of the abovementioned embodiments of the method.

The abovementioned non-volatile computer storage medium stores the computer executable instructions that, when executed by the electronic device, enable the electronic device to: judge whether a mobile phone has an incoming call or not, acquire a first kinematic acceleration of the mobile phone if the mobile phone has an incoming call; judge whether the first kinematic acceleration is greater than a first threshold or not, and answer the call if the first kinematic acceleration is greater than the first threshold.

For the non-volatile computer storage medium, where, acquiring the first kinematic acceleration of the mobile phone includes: acquiring a first acceleration of an X axis of the mobile phone in a horizontal moving direction; acquiring a second acceleration of a Y axis of the mobile phone in a vertical moving direction; acquiring a third acceleration of a Z axis in an earth gravity field direction; and obtaining the first kinematic acceleration according to the first acceleration, the second acceleration and the third acceleration.

For the non-volatile computer storage medium, where, the mode of obtaining the first kinematic acceleration according to the first acceleration, the second acceleration and the third acceleration is:

N=\sqrt{X²+Y²+Z²}, where

N is the first kinematic acceleration;
X is the first acceleration;
Y is the second acceleration; and
Z is the third acceleration.

The non-volatile computer storage medium further judges whether the first kinematic acceleration is greater than a second threshold or not when the first kinematic acceleration is not greater than the first threshold, where the second threshold is smaller than the first threshold; further acquires a second kinematic acceleration of the mobile phone if the first kinematic acceleration is greater than the second threshold, judges whether the second kinematic acceleration is greater than the second threshold or not, and hangs up the incoming call if the second kinematic acceleration is greater than the second threshold.

The abovementioned non-volatile computer storage medium stores computer executable instructions that, when executed by the electronic device, enable the electronic device to: judge whether the mobile phone is busy or not, and acquire a third kinematic acceleration of the mobile phone if the mobile phone is busy; and judge whether the third kinematic acceleration is greater than the first threshold or not, and hang up the call if the third kinematic acceleration is greater than the first threshold.

### Embodiment 4

FIG. 3 is a schematic diagram of a hardware structure of the electronic device for executing the method for operating a mobile phone in the present embodiment, and as shown in FIG. 3, the device includes one or more processors 4 and a memory 3, and one processor 4 is taken as an example in FIG. 3; and the electronic device for executing a multimedia photo generating method may also include: an input device 630 and an output device 640.

The processor 4, the memory 3, the input device 630 and the output device 640 may be connected with a bus or in other ways, and bus connection is taken as an example in FIG. 3.

The memory 3, as a non-volatile computer readable storage medium, may be used for storing non-volatile software programs, non-volatile computer executable programs and modules, for example, program instructions/modules (e.g., the first kinematic acceleration acquisition module 1 and the monitoring module 2 shown in FIG. 2) corresponding to the method for answering and hanging up an incoming call of a mobile phone in the embodiments of this disclosure. The processor 4 runs the non-volatile software programs, instructions and modules stored in the memory 3, so as to execute various functional applications and data processing of a server, namely implementing the method for answering and hanging up an incoming call of the mobile phone in the abovementioned embodiments of the method.

The memory 3 may include a program storage area and a data storage area, where the program storage area may store an operating system and applications for at least one functions; and the data storage area may store data and the like created according to the use of a multimedia photo generating device. Moreover, the memory 3 may include a high-speed random access memory, and may also include a non-volatile memory, for example, at least one disk storage device, a flash memory, or other non-volatile solid storage devices. In some embodiments, the memory 3 optionally includes memories that are set remotely relative to the processor 4, and these remote memories may be connected to the device for answering and hanging up an incoming call of a mobile phone through a network. An example of the network includes, but is not limited to, internet, intranet, LAN, mobile communication network, and the combinations thereof.

The input device 630 may receive input digit or character information and generate a key signal input related to the user configuration and function control of the device for answering and hanging up an incoming call of a mobile phone. The output device 640 may include display devices such as a display screen.

The one or more modules are stored in the memory 3, and when executed by the one or more processors 4, perform the method for answering and hanging up an incoming call of a mobile phone in any one of the abovementioned embodiments of the method.

The electronic device for executing the method for answering an incoming call of a mobile phone includes: at least one processor, and a memory in communication connection with the at least one processor, where, the memory stores instructions that can be executed by the at least one processor, and the instructions are executed by the at least one processor to enable the at least one processor to: judge whether a mobile phone has an incoming call or not, acquire a first kinematic acceleration of the mobile phone if the mobile phone has an incoming call; judge whether the first kinematic acceleration is greater than a first threshold or not, and answer the call if the first kinematic acceleration is greater than the first threshold.

For the electronic device, where, acquiring the first kinematic acceleration of the mobile phone includes: acquiring a first acceleration of an X axis of the mobile phone in a horizontal moving direction; acquiring a second acceleration of a Y axis of the mobile phone in a vertical moving direction; acquiring a third acceleration of a Z axis in an earth gravity field direction; and obtaining the first kinematic acceleration according to the first acceleration, the second acceleration and the third acceleration.

For the electronic device, where, the mode of obtaining the first kinematic acceleration according to the first acceleration, the second acceleration and the third acceleration is:

N=\sqrt{X²+Y²+Z²}, where

N is the first kinematic acceleration;
X is the first acceleration;
Y is the second acceleration; and
Z is the third acceleration.

The electronic device further judges whether the first kinematic acceleration is greater than a second threshold or not when the first kinematic acceleration is not greater than the first threshold, where the second threshold is smaller than the first threshold; further acquires a second kinematic acceleration of the mobile phone if the first kinematic acceleration is greater than the second threshold, judge whether the second kinematic acceleration is greater than the second threshold or not, and hangs up the incoming call if the second kinematic acceleration is greater than the second threshold.

The electronic device for executing the method for hanging up a call of a mobile phone includes: at least one processor 6, and a memory 5 in communication connection with the at least one processor, where the memory 5 stores instructions that can be executed by the at least one processor 6, and the instructions are executed by the at least one processor 6 to enable the at least one processor 6 to: judge whether the mobile phone is busy, acquire a third kinematic acceleration of the mobile phone if the mobile phone is busy; and judge whether the third kinematic acceleration is greater than the first threshold or not, and hang up the call if the third kinematic acceleration is greater than the first threshold.

The abovementioned product can perform the method provided by the embodiments of this disclosure and have corresponding functional modules for executing the method and beneficial effects. For those technical details that are not described in detail in the present embodiment, please refer to the method provided by the embodiments of this disclosure.

The electronic device of the embodiments of this disclosure exists in many forms, including but not limited to the following devices:

(1) Mobile communication devices: the characteristic of such devices is that they have a mobile communication function with a main objective of enabling voice and data communication. Such terminals include: smart phones (such as iPhone), multimedia phones, feature phones, low-end phones, etc.

(2) Ultra-mobile personal computer devices: such devices belong to the category of personal computers, have computing and processing functions, and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, smart toys, and portable vehicle navigation devices.

(4) Servers: devices providing computing services. The structure of a server includes a processor, a hard disk, an internal memory, a system bus, etc. A server has architecture similar to that of a general purpose computer, but in order to provide highly reliable services, the server has higher requirements in aspects of processing capability, stability, reliability, security, expandability, manageability, etc.

(5) Other electronic devices having data interaction function.

The abovementioned embodiments of the device are only illustrative, where the units described as separate parts may be or may not be physically separated, the components shown as units may be or may not be physical units, i.e. may be located in one place, or may be distributed at multiple network units. According to actual needs, part of or all of the modules therein may be selected to realize the objectives of the technical solution of the embodiment.

By abovementioned descriptions of the embodiments, those skilled in the art can clearly understand that the various embodiments may be implemented by software and a general hardware platform, and of course, may also be implemented by hardware. Based on such understanding, the abovementioned technical solution in essence, or the part thereof making a contribution to a related technology, may be embodied in the form of a software product, and such computer software products may be stored in a computer readable storage medium such as an ROM/RAM, a magnetic disk or an optical disk, etc., and may include a number of instructions to enable a computer device (which may be a personal computer, a server, or a network device, etc.) to execute the method described in the various embodiments or in some parts thereof.

Finally, it should be noted that: the abovementioned embodiments are merely illustrated for describing rather than limiting the technical solution of this disclosure; although detailed description of this disclosure is given with reference to the abovementioned embodiments, those skilled in the art should understand that they still can modify the technical solution recorded in the abovementioned various embodiments or replace part of the technical features therein with equivalents; and these modifications or replacements would not cause the essence of the corresponding technical solution to depart from the spirit and scope of the technical solution of the various embodiments of this disclosure.

What is claimed is:

1. A method for operating a mobile phone, comprising the following steps:
judging whether a mobile phone has an incoming call or not, acquiring a first kinematic acceleration of the mobile phone if the mobile phone has an incoming call;
judging whether the first kinematic acceleration is greater than a first threshold or not, and answering the call if the first kinematic acceleration is greater than the first threshold.

2. The method according to claim 1, wherein the step of acquiring the first kinematic acceleration of the mobile phone comprises:
acquiring a first acceleration of an X axis of the mobile phone in a horizontal moving direction; acquiring a second acceleration of a Y axis of the mobile phone in a vertical moving direction; acquiring a third acceleration of a Z axis in an earth gravity field direction; and
obtaining the first kinematic acceleration according to the first acceleration, the second acceleration and the third acceleration.

3. The method according to claim 2, wherein the step of obtaining the first kinematic acceleration according to the first acceleration, the second acceleration and the third acceleration is:
N=\sqrt{X²+Y²+Z²}, wherein
N is the first kinematic acceleration;
X is the first acceleration;
Y is the second acceleration; and
Z is the third acceleration.

4. The method according to claim 1, further comprising the following steps:
further judging whether the first kinematic acceleration is greater than a second threshold or not when the first kinematic acceleration is not greater than the first threshold, wherein the second threshold is smaller than the first threshold; and
further acquiring a second kinematic acceleration of the mobile phone if the first kinematic acceleration is greater than the second threshold, judging whether the second kinematic acceleration is greater than the second threshold or not, and hanging up the incoming call if the second kinematic acceleration is greater than the second threshold.

5. The method according to claim 1, characterized in also comprising:
judging whether the mobile phone is busy, acquiring a third kinematic acceleration of the mobile phone when the mobile phone is busy;
judging whether the third kinematic acceleration is greater than the first threshold or not, and hanging up the call if the third kinematic acceleration is greater than the first threshold.

6. An electronic device, comprising: at least one processor, and a memory in communication connection with the at least one processor, wherein the memory stores instructions that can be executed by the at least one processor, and the instructions are executed by the at least one processor to enable the at least one processor to:
judge whether a mobile phone has an incoming call or not, acquire a first kinematic acceleration of the mobile phone if the mobile phone has an incoming call;
judge whether the first kinematic acceleration is greater than a first threshold or not, and answer the call if the first kinematic acceleration is greater than the first threshold.

7. The electronic device according to claim 6, wherein acquiring the first kinematic acceleration of the mobile phone comprises:
acquiring a first acceleration of an X axis of the mobile phone in a horizontal moving direction; acquiring a second acceleration of a Y axis of the mobile phone in a vertical moving direction; acquiring a third acceleration of a Z axis in an earth gravity field direction; and
obtaining the first kinematic acceleration according to the first acceleration, the second acceleration and the third acceleration.

8. The electronic device according to claim 7, wherein the mode of obtaining the first kinematic acceleration according to the first acceleration, the second acceleration and the third acceleration is:
N=\sqrt{X²+Y²+Z²}, wherein
N is the first kinematic acceleration;
X is the first acceleration;
Y is the second acceleration; and
Z is the third acceleration.

9. The electronic device according to claim 6, wherein
whether the first kinematic acceleration is greater than a second threshold or not is further judged when the first kinematic acceleration is not greater than the first threshold, wherein the second threshold is smaller than the first threshold; and
a second kinematic acceleration of the mobile phone is further acquired if the first kinematic acceleration is greater than the second threshold, whether the second kinematic acceleration is greater than the second threshold or not is judged, and the incoming call is hung up if the second kinematic acceleration is greater than the second threshold.

10. The electronic device according to claim 6, wherein the memory stores instructions that can be executed by the at least one processor, and the instructions are executed by the at least one processor to enable the at least one processor to:
judge whether the mobile phone is busy, acquire a third kinematic acceleration of the mobile phone when the mobile phone is busy; and
judge whether the third kinematic acceleration is greater than the first threshold or not, and hang up the call if the third kinematic acceleration is greater than the first threshold.

11. A non-volatile computer storage medium, storing computer executable instructions that, when executed by the electronic device, enable the electronic device to:
judge whether a mobile phone has an incoming call or not, acquire a first kinematic acceleration of the mobile phone if the mobile phone has an incoming call; and
judge whether the first kinematic acceleration is greater than a first threshold or not, and answer the incoming call if the first kinematic acceleration is greater than the first threshold.

12. The non-volatile computer storage medium according to claim 11, wherein the computer executable instructions, when executed by the electronic device, enable the electronic device to:
judge whether the mobile phone is busy, acquire a third kinematic acceleration of the mobile phone when the mobile phone is busy;
judge whether the third kinematic acceleration is greater than the first threshold or not, and hang up the call if the third kinematic acceleration is greater than the first threshold.
